(19) United States
(12) Patent Application Publication
(10) Pub. No.: US 2016/0091186 A1
(43) Pub. Date: Mar. 31, 2016

(54) Self-Contained and Safety Module for Lighting Wearing Apparel

(71) Applicant: Wilson Chow, Brooklyn, NY (US)

(72) Inventor: Wilson Chow, Brooklyn, NY (US)

(21) Appl. No.: 14/496,096

(22) Filed: Sep. 25, 2014

(51) Int. Cl. F21V 23/02; A43B 3/00; F21L 4/00; F21V 33/00; F21V 23/04

(52) U.S. Cl. CPC F21V 23/023; F21V 33/0008; F21V 23/0414; F21L 4/00; A43B 3/001

(57) ABSTRACT

An article of apparel has a sealable cylindrical compartment for a lighting device which is housed in a sealed casing within the compartment. The compartment and casing are designed such that the batteries of the device can be accessed and resealed by an adult but not accessible by a child. When the article is a shoe, a covering insole conceals the compartment with a tab attached to enable a user to easily remove the insole and expose the casing. The sealable casing may have an open end and a lid attached by a small-headed screw. The perimeter edge of the lid can mate with the edge of the casing to further secure the lid. In another embodiment, the sealable casing is secured within the compartment.

### FIELD OF THE INVENTION

The present invention relates to a module or device intended to be integrated into an article of apparel. The module provides a power source (one or two batteries), a small light, and a switch (simple on-off toggle, accelerometer, etc.). An integrated circuit can be provided, too, for having the light flicker, change colors, illuminate based on timing, etc. The light, power sources, controls are housed inside a compact module which is insertable into a hidden compartment within the article of wearing apparel. A cover seals the compartment with the lighting module inside, protecting it from being easily disassembled by a child, keeping it free from water or other elements that the user might encounter. In the case of a shoe, the lighting module fits within a preferably cylindrical chamber or compartment within the heel of the shoe and concealed by the shoe's insole which has an attached tab for easy access, when needed. The lighting module or device is protected from child access by a screw cover which can only be removed by use of a tool. This would allow an adult to change batteries or to remove the module, if needed.

### BACKGROUND OF THE INVENTION AND DISCLOSURE

For generations, manufacturers have incorporated novelties into article of apparel to attract buyers and encourage sales. Lighting is one of such novelties, being provided to jewelry, children's pajamas, children's clothing, and children's toys. Lighting, however, requires power, often in the form of battery(ies), a light to be illuminated and a switch to connect the power to the light. Often, one or more lights are connected to the power and they can alternate in illumination, in specific designs, as set by a controlling integrated circuit. The switches which have been employed in the past have been simple toggle on-off switches, a contact switch so that when the light module comes into contact with a hand, the floor, or ground the switch closes the circuit and the light(s) illuminate, and accelerometer switches which close the circuit based on speed of movement of the circuitry. These “packages” have been integrated into sneakers for allowing joggers to be seen at night; into children's' shoes for novelty effect, into children's pajamas (removable packages to allow for washing without degradation of the circuitry/electronics), etc. Substantially all of these devices for apparel require small batteries for providing the electricity to power the circuit. Yet, batteries within children's apparel can create difficulties and other issues. For example, it is important that children not have direct access to these batteries as they can be accidentally ingested to negative medical effect. Yet, some countries require access to batteries in small electronics for replacement purposes. These two countervailing conditions require a novel solution, provided by the present invention—a fully enclosed module for the light, switch, circuitry and batteries which is child-proof and, yet, provides selective access to an adult for replacement, as needed, of the batteries. And, to complicate the problem, the solution must be capable of being contained in a small article of wearing apparel, for example, a heel of a “princess” shoe or slipper.

Electrical malfunctions with battery powered devices can cause the products to stop working, or worse, lead to possible shocks and even sparks. Also, batteries eventually dissipate and run out, and if they are not replaced, the lighting will cease to function entirely. And, some localities require that batteries be removable from the item for proper disposal in an environmentally sound manner. Thus, access to the batteries is often important and, yet, ensuring lack of access to the child is important, too. In addition, the entire assembly needs to be highly compact for purposes of manufacturing, shipping, installation, and removal, especially in that children's articles of wearing apparel are small in size and shape.

To avoid the complications of electricity and batteries, many manufacturers simply lock the batteries inside their products. This prevents them from posing serious dangers to children and swallowing of the same but also prevents them from being separately and properly disposed of and being easily, if at all, replaced when their life expires. This mean that once the battery(ies) run out, the product will never work again. It also prohibits the product from being sold in countries that require battery-operated products to have replaceable batteries, such as many European countries. These problems raised by battery-powered products create a need for a self-contained, protected, yet accessible, battery compartment in electrical connection to one or more lights, a switch and the Integrated Circuit (IC), if any. The present invention is directed to providing a sealed battery cell (one or more batteries), one or more illuminating lights, a switch, and an IC, too, in a modular-like holding cylinder which is easily placeable into a suitably shaped compartment within articles of apparel which enables the battery to be accessed and resealed in the compartment again when replacement batteries are desired, batteries removed for proper disposal, and, in addition, prevents children from having easy access to the same, all within an article of wearing apparel.

### DESCRIPTION OF PRIOR ART

To the Applicant's knowledge, no prior art articles of apparel combine the structural features and functionality of a small, compact, sealable compartment for a battery-driven lighting device which fits inside a suitably shaped holding compartment in the apparel. Thus, it is advantageous to provide articles which contain all of these components for the purpose of prolonging the use of the article while maintaining the safety of the device from young children.

Apparel has been provided with lighting mechanisms, driven by batteries and having an on-off switch. For example, children pajamas and t-shirts have been provided which have openable pouches which contain removable pouches—the pouches containing one or more batteries, one or more electric lights, and an on-off switch (usually a push-button type). Yet, those sealed pouches do not allow for the batteries to be separated from the other electronics, inhibiting the replacement of the batteries, as needed and also inhibiting the proper ecological disposal of the same.

Similarly, shoes, specifically sneakers, have been provided for joggers and others where the heel of the footwear is provided with an insert comprising a light, battery, and the heel contains an pressure sensitive on-off switch such that running on a hard surface causes the light to be connected in circuit with the power to illuminate the light. This is believed very effective for preventing accidents in night running as cars and others easily see the lighted heels of the runners.

Other and similar footwear products have been commercialized which include similar electronics but where the switch is a simple on-off toggle switch located at or near the upper and tongue of the sneaker. All of these, however, have the electronics permanently secured into the heel or other part of the shoe, preventing ease of battery removal for proper disposal and also preventing replacement of batteries.

Other articles of wearing apparel have been commercialized by costume manufacturers. These have had integrated lighting effects, too. The batteries are accessible and replaceable but, as a consequence, the batteries are just as accessible to small hands and mouths of young children. To Applicant's knowledge, there has not been an integrated lighting module for articles of clothing which is contained to avoid easy direct contact by small children with the batteries and other components and, yet, allows for adult access for battery removal and replacement, if desired, all in a small piece of footwear or article of clothing. Having the present invention received within a cylindrical chamber in the heel of a “princess” heel, covered by a foot or sole pad, wherein the heel is translucent (so that the flashing light passes through he clear cylinder within which all components are contained and then through the heel, creates a pleasing visual effect). The present invention solves many problems of the prior art devices.

### SUMMARY OF THE INVENTION

The present invention is directed to articles of apparel having a sealable compartment for a lighting module or device, which is basically a sealed casing only capable of being opened by an adult with a tool and with adult-like manual dexterity. The compartment for the module and the casing of the module are both selectively openable so that an adult can gain access to the batteries for disposal and replacement. The lighting lamp, batteries, switch and IC all snugly and compactly fit into the cylindrical casing and the cylindrical casing is adapted to slide into and fit securely inside of a similarly sized and shaped cylindrical compartment. In the preferred embodiment, the casing and compartment are transparent or at least translucent, made of plastic or clear rubber, so that the light within the casing will be visible through both the casing and the compartment to a pleasing visual effect. The casing is further designed such that the batteries can be accessed and resealed inside the casing but only by access by an adult and the compartment, too, is accessible only by first lifting a sole pad of the shoe and then by removing a covering disc of the compartment, thus revealing the casing.

In one embodiment of the invention, the article is a child's small shoe, designed like a princess shoe, with a clear rubber/plastic small “high” heel. The floor-contacting end of the heel of the shoe is solid. The other or inside end of the heel of the shoe provides a top-open compartment in a cylindrical shape for receipt of the casing of the electronic components. The shoe further comprises an insole which conceals the cylindrical compartment in the heel for the casing for the light, switch, batteries and IC. The insole or footpad is provided with an extending tab attached to the heel end to enable a user to easily remove the insole. There, a frictionally held cap can be removed by an adult, thereby exposing the casing for the components. Yet, the casing can only be removed from its holding compartment (in the heel) by use of a small tool (pair of needle nose pliers) and, then, the cap of the casing can only be removed by turning screw threads thereon to open up the casing, exposing the replacement and removable batteries.

In one embodiment, the preferably small cylindrical sealable casing of the lighting device has a solid first end, inserted downwardly into the cavity in the heel, and an opposite and open end. A screw-threaded sealing lid is adapted to mate with the threads of the open end. The open end and the lid are attached by male and female screw threads—external threads for the lid and internal threads for the casing. In an embodiment, the sealable casing is secured with its lid and includes an attached upwardly extending ear or tab for easily removal by an adult with the appropriate tools only. Such an ear might also include an aperture for further ease of access.

In one embodiment, the casing is secured within a cylindrical cavity, within the heel of a shoe, beneath the footpad or insole. In an embodiment, the casing is maintained within the cylindrical chamber or compartment just beneath the foot pad and/or a friction fit cover can be provided too. It, too, is expected to prevent the easy access by a child but, conversely removal, as desired, by an adult who can simply pry the cover off of the heel (from the inside of the shoe) thereby exposing the casing and the compartment.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a side perspective and exploded view of the preferred embodiment of the invention, a child's slipper or heeled shoe showing the components of the invention and

FIG. 2 is a side view of an exploded integrated module, comprising cylindrical and transparent casing, batteries, switch (motion or contact sensing) IC, light and screw on cap.

FIG. 3 is a bottom perspective and exploded view of an alternative construction of the invention, showing the components being installed through the bottom of the heel instead of the from the top inside of the heel.

### DETAILED DESCRIPTION OF THE DRAWINGS AND PREFERRED EMBODIMENTS

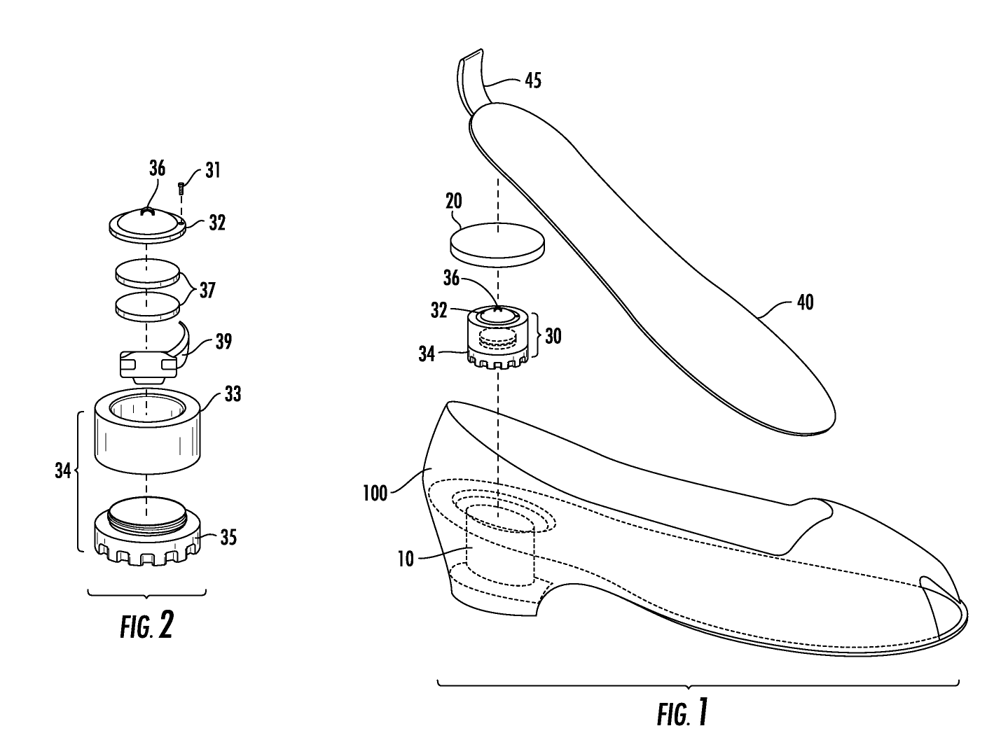

FIG. 1 generally depicts an article of wearing apparel 100, preferably for children, with compartment 10, in the preferred embodiment, a cylindrically-shaped holding compartment in the heel of the shoe. Article 100 in the preferred embodiments is a child's “glass” slipper, an elegant shoe for a young girl pretending to be or playing a Princess role. Preferably, the shoe's outer is made from resilient rubber or plastic and the heel is preferably transparent but sturdy plastic, at least translucent. Other materials can be used, too, but for best effect, the heel of the shoe or the holding compartment should be clear, substantially transparent or translucent. In one embodiment the heel is formed by a plastic molded and integrated with the flat outside sole of the shoe and further, to advantage, integrated glitter therein such that when the heel is illuminated from the inside, a visually pleasing effect is provided, with the light being dispersed in many directions and possibly many colors by the entrained glitter. The cylindrical compartment 10 is closed, preferably, at the bottom of the heel of the shoe. In one embodiment of the invention, the compartment has an opening adjacent to the bottom of the heel and the top of the compartment, just below the inner sole (in contact with the sole of the wearer's foot) is closed. In FIG. 1, the bottom of the heel is provided with a rubber heel piece 11. The cylindrical compartment 10 has a flat, bottom wall 13 and an opening or top 15. The side wall 17 of the compartment 10 is adapted to receive, in shape and size, the lighting module 30. The upper (portion which holds the shoe to the wearer's foot) of the shoe 100 can be any material, fabric, rubber, plastic, etc. but it needs to be comfortable and adaptable to be worn on the foot of a child. The physical design of the upper is moldable or changeable by the manufacturer and designer of the same, and the sides of the upper, the toe, the back, can be modified without departing from the present invention. Cylindrical compartment 10 is shown in FIG. 1 as integrated and forms a part of the heel 19 of the shoe article 100. FIG. 1 also shows cylindrical and lighting module or casing 30.

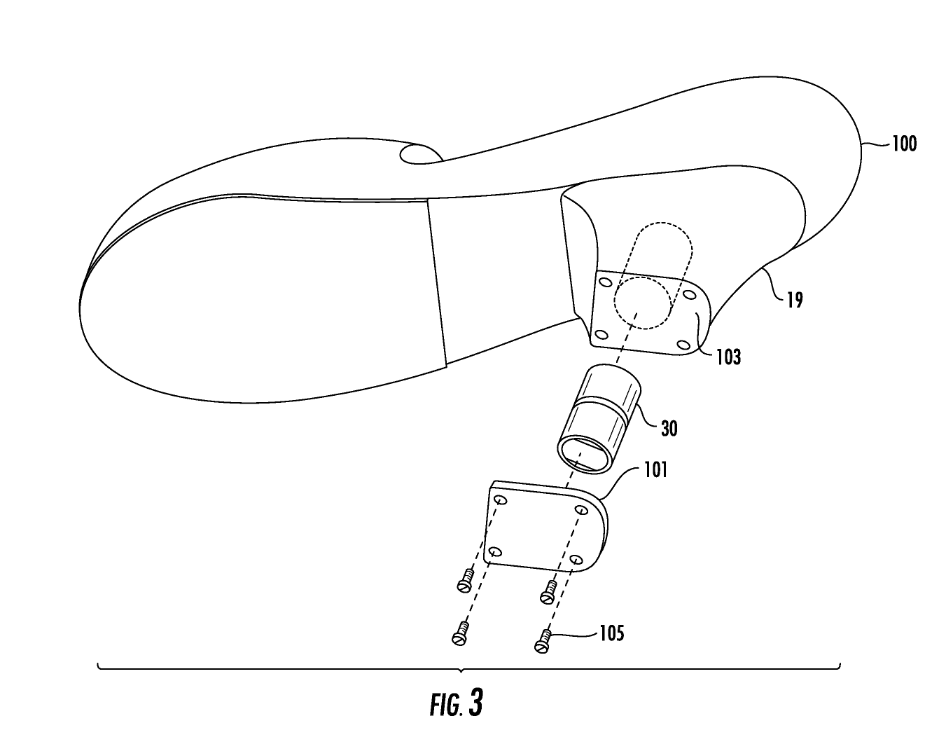

Casing 30 is a cylindrically-walled and preferably hard plastic holding container for the electronics of the present invention. As mentioned, it encloses the batteries, light, switch and IC so that a small child can not gain access and, yet, an adult will be able to remove the same, open the container and remove for replacement and/or disposal of the batteries. It, too, has a bottom (see FIG. 2), and at least a smooth wall outside wall, an inside cylindrical wall, a top, and bottom. Preferably, the entire container or casing is made of a transparent or translucent material. The outside wall 21 of casing 30 is slightly less in diameter than the inside diameter of the compartment 10 so that the casing 30 can be inserted into the compartment, when desired, and removed for access to the batteries for replacement or for disposal of the batteries with or without the other electronic components, but separated from the shoe.

The casing 30 contains and comprises a lighting device 39 , an electric cell, battery or pair of batteries 37, an on-off switch 39 (preferably motion sensor, contact activated, on-off toggle which can be connected to a physical switch on the outside of the shoe or the heel) and an integrated circuit 41. These components fit within the cylindrical casing and the casing slides within the cylindrical compartment. 10.

Compartment 10 is then sealed by a top plug 20. The bottom of the exterior wall of top plug 20 is provided with outside screw threads which mate with top and inside screw threads on the top of the opening to the casing 30. The top plug 20 seals and provides an extra level of safety as it is frictionally held into the compartment by mechanical cooperation with the flange 53 of the compartment 51. In a preferred embodiment of the invention, the compartment 10 is provided, at the top of the opening with an inwardly directed flange 51 for support and frictional contact with the top plug 20. The top plug 20, when in place, covers the compartment, with the casing therein, and presents a smooth continued bottom for the inside sole of the shoe. A sole pad 40 is provided, extending the length of the shoe, from back to toe, side to side, to provide comfort to the wearer and to hide the top plug 20 and the casing 30 within the compartment 10. The sole pad 40 is preferably provided with a rear tab or tongue 45, at the back of the pad to enable an adult to remove the pad 40 to expose the top plug 20 and to thereby gain access to the compartment 10 and the casing 30 (with access thus to the batteries).

In a preferred embodiment of the invention, the compartment is provided, at its top, with an inwardly directed flange 51 which is adapted to frictionally support and hold a top plug 20, whose outside circumference and configuration at its bottom fits within the outside of the opening 53 of the compartment 10. Top plug 20 can have an inwardly tapered, downwardly extending wall 55 for an easy friction fit. In the preferred embodiment depicted in FIG. 1, article 100 is a slipper or shoe and further includes a bottom sole pad or soft insole 40 with an easy pull tab 45 located toward the heel end of the shoe.

It should be noted that while FIG. 1 depicts a preferred embodiment, other variations of the invention can exist and function successfully. In FIG. 1, article 100 is a shoe and compartment 10 is located in the heel, but it may just as well be in a platform in the shoe, or in a pocket on the body of the article of apparel, whatever the article of apparel may be (costume, shirt, jacket, pants, boots, etc.). Further, it should be noted that the casing 30 and compartment 10 are circular in the drawings but they can be any shape and size which will fit in a shoe or article of wearing apparel. The casing for the electrical components is meant to easily and stably slide into and out of and to fit within the compartment within the article of wearing apparel. For example, the compartment 10 and the casing 30 might be uniquely shaped (five pointed star shape) to mate and lock when casing 30 is in place. In another example, they may be shaped to fit in an otherwise difficult to accommodate and “hidden” location, such as to fit in between support structures. The casing may actually be placed into the heel of the shoe from and through an opening just above the rubber heel piece 11 and the top of the heel, adjacent and below the sole pad 40, may not be the point of access and can be closed.

According to the preferred embodiment of the invention, the lid 32 of the cylindrical casing 30 is provided with an upwardly extending ear 36 with a small aperture 37 therethrough. At the bottom of the lid 32, a set of external screw threads mate with the internal screw threads at the top of the casing's side wall. Thus the lid 32 can be screwed onto the casing and unscrewed for gaining access to the electric components, especially the top-located batteries therein. The ear is quite small and difficult to turn without use of a tool (needle nose or other pair of pliers). The hole in the ear allows for a paper clip to be passed therethrough for removing the entire casing from the compartment but it should be appreciated that the lid 32 can only be removed from the casing's side wall and top opening by use of a tool; the torque needed to unscrew the lid from the casing is relatively high so that use of a tool is desirable, if not necessary.

The purpose of the casing 30 is to protect the electronics 39 from damage while allowing the electronics and specifically the batteries 39 to be accessible to an adult. The wall of the casing 30 should be shaped and thick enough to protect the electronics of the lighting device 39 yet thin enough to allow light glowing within the casing to pass into and through the heel and then to be visible by others. Lighting device 39 is comprised of a simple integrated circuit (IC) board, and other necessary parts, that cause the device to light up. One skilled in the art will recognize, though, that alternatively the device may in place make sounds or measure distance traveled, to name a few possibilities. An alternative embodiment to the use of a cylindrical casing with a top opening, solid bottom and full height side wall would be to provide both a top and bottom casing of similar sizes (like half-egg shells) which fit together to form a protective casing.

In order to properly protect the lighting device 39, casing 30 is sealable. This means that casing 30 is configured in such a way that when closed, external elements (water and dirt, for example) cannot reach lighting device 39 inside. Casing 30 however is also built such that it can be opened and resealed upon closing again. To achieve this, in the preferred embodiment casing 30 consists of a container with an open end, a lid 32 covering the open end and a mechanism such as screw threads 31 (which mate with screw threads at the top of the opening of the casing) for locking the lid 32 in place and sealing the container closed. The lid 32 might also be tapered or shaped such that its perimeter edge mates with the top circumferential edge of the container to lock the same more tightly.

In a preferred embodiment, the casing 30 also includes a tab or upwardly extending ear 36 which allows a user to retrieve the device from compartment 10. As a safety precaution, casing 30 may fit tightly within compartment 10 so that children cannot easily reach the electrical components. In this case, this tab or ear 36 will be essential for access. To make the casing 30 further accessible, ear 36 might include an aperture which would allow the user to remove the casing 30 with a tool, such as a pair of needle nose pliers or even a safety pin or paper clip.

In FIG. 1, compartment 10 is covered and sealed by top plug 20, although it is possible that based on the configuration and placement of compartment 10, that plug 20 is not necessary. For example, if compartment 10 were located on the side of the heel of the shoe which firmly slid within and was contained therein, then the casing 30 could be secured and a plug 20 might not be necessary. However, in a preferred embodiment, plug 20 acts to further protect and conceal the casing 30, as well as to allow the article of wearing apparel to function as expected despite the addition of a holding compartment and electronics within a casing within the compartment. Top plug 20 can take other forms also. For example if the compartment had an opening on the side of the the heel rather than at the top plug 20 could take the form of a side wall closing device. In yet another embodiment top plug 20 may be attached to the body of the shoe by a hinge and be secured in whatever manner necessary, such as by pins or a tab held by a corresponding slot. Other mechanical embodiments can be provided, too. Top plug 20 may further be shaped such that its perimeter edge sealingly mates with the edge of compartment 10. This embodiment would provide an additional measure to ensure that casing 30 is properly protected.

FIG. 1 also shows insole 40 which is appropriate when article 100 is a shoe. Insole 40 is a removable, soft material located inside the shoe that further conceals compartment 10 and top plug 20 but otherwise functions as a normal insole to line the shoe's interior. Insole 40 contains a gripping tab 45, preferably at the heel end of the insole, to enable a user to pull the insole upwardly and out easily. Because insoles are often pushed down into the shoe from wear, having a pull tab on the insole will greatly improve the ease at which it can be removed. Because the insole may shift while a user wears the shoe, one might prefer to attach the insole to the shoe at certain points with glue, thread, or the like, and leave only the portion covering compartment 10 to be upwardly removable.

FIG. 2 depicts the details of sealable casing 30. Casing 30 comprises a plastic cylindrical container 34 and closing lid 32. Although described here as a plastic container, one skilled in the art will recognize that the container can be made from many other materials including a variety of metals. However, if the container is metallic, then the light of the electronics needs to a) be exterior to the container and b) there must be an electrical connection between the light and the power and switch device. Plastic container 34 houses lighting device 39, along with any device accessories such as batteries 37 and a switch or a motion sensor in the preferred embodiment. As shown, casing 30 may be made from multiple parts or alternatively be one molded single piece. Lid 32 is removably secured to plastic container 34 to enclose the lighting device inside, yet allow access to the device when necessary. One skilled in the art will appreciate that many mechanisms exist for removably securing lid 32 to plastic container 34. In the preferred embodiment a metal screw 31 also secures the two components although external screw threads to the lid and internal screw threads can be used on the respective mating parts. However, according to a preferred embodiment of the invention, a small metal screw 31 has a head secured to the outside of the lid 31 with screw threads which are received by a small tube 70 with internal screw threads 71. This small screw will hold the lid 32 to the otherwise open end of the container and requires the use of a tool, a small screwdriver, by an adult for removal of the lid 32 to gain access to the batteries. However, a pin or a tab, for example, may be used as well. Alternatively, lid 32 may be shaped such that its perimeter edge mates and locks with the edge of container 34 to more securely connect the elements which decoupling should require at least two mechanical motions (similar to a safety container for prescriptive drugs and pills) for uncovering.

The integrated circuit IC will provide timing and power, from the batteries, based on the switch provided. In one example, an IC can have the light pulsate, seemingly randomly, or have several small LED's or lights flash at different or the same time. The IC is a conventional item capable of being purchased from several sources. The batteries and lights, LED's, for preferred example, and the small disc, watch like size batteries, are conventional, too.

As can be seen in FIG. 3, the shoe 100 with heel 19 can be provided with the casing through the bottom of the heel, instead of through an opening in the top of the heel, beneath the protective sole pad or cushion. Here, for example the cylindrical compartment is formed into the heel with the opening of the compartment extending to the bottom of the plastic heel and the top of the compartment is closed off and spaced from the cushioned sole pad. The casing, with integrated circuit, light(s), switch, and batteries, is inserted into the compartment through the bottom of the heel until the top of the casing is flush against the closed off end of the compartment. Then, the bottom of the casing is substantially coplanar with the bottom of the heel 19. A lid can be provided to hold the casing within the compartment or, alternatively, the heel cap 101 can be secured to the bottom 103 of the heel 19m without any lid between the bottom of the casing and the top of the heel cap. The heel cap 101 is secured to the heel 19 via a set of small screws 105.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed is:

1. An article of apparel comprising:
an electronics holding compartment formed in said article of apparel having at least a portion thereof made of translucent material;
a lighting device comprising an electric circuit comprised of one or more lights, a source of power and a switch for illuminating the lights when said switch closes said circuit, said lighting device being fully surrounded by a sealable casing;
said sealable casing configured to be opened but only with a tool and resealed; and
said sealable casing further sized and shaped to fit snugly within said compartment.

2. The article of apparel as in claim 1 where the article of apparel is a shoe, said compartment is within the heel of said shoe and further comprises an insole which conceals said compartment and wherein said insole has a gripping tab attached thereto.

3. The article of apparel as claimed in claim 1 wherein said electronics holding compartment further comprises a plug mechanically sealing said compartment.

4. The article of apparel as claimed in claim 1 wherein said sealable casing comprises:
a cylindrical container having one open end;
a lid sealingly covering said open end; and
a mechanical mechanism for removably securing said lid to said container.

5. An article of apparel as claimed in claim 4 wherein said mechanical mechanism is a screw held against said lid and by said cylindrical container.

6. An article of apparel as claimed in claim 4 wherein said lid is configured and shaped such that its perimeter edge sealingly mates with said open end of said container.

7. An article of apparel as claimed in claim 4 wherein said casing further consists of an upwardly extending ear with an aperture therethrough.

8. An article of apparel as claimed in claim 1 wherein said casing is cylindrical, said compartment is cylindrical and said compartment is located in the heel of a child's shoe.

9. The article of apparel as in claim 1 where the article of apparel is a shoe, said compartment is within the heel of said shoe and said compartment is accessible through the base of said heel.
